(19) United States
(12) Patent Application Publication
(10) Pub. No.: US 2003/0226694 A1
(43) Pub. Date: Dec. 11, 2003

(54) Core drill bit with geometrically defined cutting elements

(76) Inventor: Steven Moseley, Feldkirch-Tisis (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/456,340

(22) Filed: Jun. 5, 2003

(30) Foreign Application Priority Data
Jun. 6, 2002 (DE) 102 25 070.7

(51) Int. Cl. E21B 10/04

(52) U.S. Cl. 175/404; 175/333

(57) ABSTRACT

A core drill bit with at least two geometrically defined, flat cutting elements (2a, 2b), wherein at least a first cutting element (2a) has an axial rake angle (α₁) and a radial rake angle (β₁) and a second cutting element (2b) with an axial rake angle (α₂) and a radial rake angle (β₂) is present, wherein different axial rake angles (α₁≠α₂) and/or different radial rake angles (β₁≠β₂) are present or at least one cutting element (2a) is present with a radial rake angle not equal to zero (β₁≠0)

### BACKGROUND OF THE INVENTION

The invention is directed to a core drill bit with geometrically defined, flatsided cutting elements with end face cutting edge surfaces, preferably for cutting brittle materials such as concrete and masonry.

An axial rake angle and a radial rake angle of zero is used for a core drill bit driven rotationally about an axis of rotation and having defined, flat cutting elements, whose surface normal runs with cutting edges along the path of movement of the cutting elements. The orientation of the axial rake angle is positively defined, in the case of tilting of the cutting elements, with an offset of the end face cutting edges in the direction of the path of movement. The orientation of the radial rake angle is also defined, in the case of tilting of the cutting elements, with an offset of the radial outer cutting edges in the direction of the path of movement.

In addition, when core drilling, for example in concrete and masonry, hard or tough inclusions, such as reinforcing bars, must also be severed.

According to DE3407427, a core drill bit for brittle material has geometrically defined, flat PCD (polycrystalline diamond) cutting elements with an exclusively negative axial rake angle relative to the axis of rotation. According to DE4242465 a core drill bit with geometrically differently defined, flat PCD cutting elements that geometrically undercut each other with end face cutting edges and an exclusively negative axial rake angle. An exclusively negative axial rake angle is not optimized for imbedded tough material.

Furthermore, according to DE4341054, a core drill bit has axially and radially inclinedly projecting, geometrically defined, pin-shaped cutting elements. Cutting elements in the form of pins have a surface with cutting edges and thus consequently no rake angle as defined above.

### SUMMARY OF THE INVENTION

The primary object of the invention is an extension of the optimized area of application of a core drill bit to imbedded tough material.

Essentially, a core drill bit has at least two geometrically defined, flatsided cutting elements, wherein at least one first cutting element and a second cutting element of different axial rake angles and/or radial rake angle, or wherein at least one cutting element with a radial rake angle is present.

By the exclusively negative axial rake angle being absent at least in some cutting elements optimized relative to brittle materials, the core drill bit is extended to tough material imbedded in brittle materials, in virtue of these cutting elements with positive axial rake angle and/or a radial rake angle not equal to zero, because their cutting face edges have an improved cutting performance and the load on the cutting edges is reduced.

Advantageously, at least one cutting element has both an axial rake angle and a radial rake angle not equal to zero, wherein a smooth cut is made possible through the imbedded tough material.

In one embodiment, at least one cutting element has at least one positive axial rake angle and a positive radial rake angle, whereby only minimal cutting forces are required in the case of the tough material; however, wear also increases.

In another advantageous embodiment, at least one cutting element has a negative axial rake angle as well as a negative radial rake angle, wherein the strength of the cutting elements increases; however, high cutting forces are required in the tough material.

In a further advantageous arrangement, at least one cutting element has a positive axial rake angle as well as a negative rake angle, whereby a practical rational compromise is possible relative to the higher strength of the cutting element and lower required cutting forces in the tough material.

Advantageously, at least some different cutting elements have different axial rake angles in the axial rake angle range of between −20° to +20°, or more specifically between −10° to +5°, wherein a practical rational compromise is possible.

Further advantageously, at least several different cutting elements have different radial rake angles in the radial rake angle range of between −20° to 20°, or more specifically between −10° to +10°, wherein a practical rational compromise is possible.

In another advantageous embodiment different cutting elements are stepped in the axial rake angle range [−5°, 0°, +5°] as well as in the radial rake angle range [−5°, +5°] or [0°, +5°], wherein a practical rational compromise is possible.

In still another advantageous arrangement, different cutting elements with different axial rake angles and/or radial rake angles are arranged peripherally asymmetrically, wherein oscillations are prevented and a round cut is produced.

Advantageously, the cutting elements are formed as PCD cutting elements, which are very resistant to wear.

### BRIEF DESCRIPTION OF THE DRAWINGS

The invention will now be more completely described with reference to an advantageous exemplar embodiment, wherein:

FIG. 1 represents a core drill bit in perspective view;

FIGS. 2a, 2b diagrammatically represents a variant in cross-section viewed from the top;

FIGS. 3a, 3b diagrammatically represents a further variant in cross-section viewed from the top; and

FIGS. 4a, 4b diagrammatically represents a still further variant in cross-section viewed from the top.

### DETAILED DESCRIPTION OF THE INVENTION

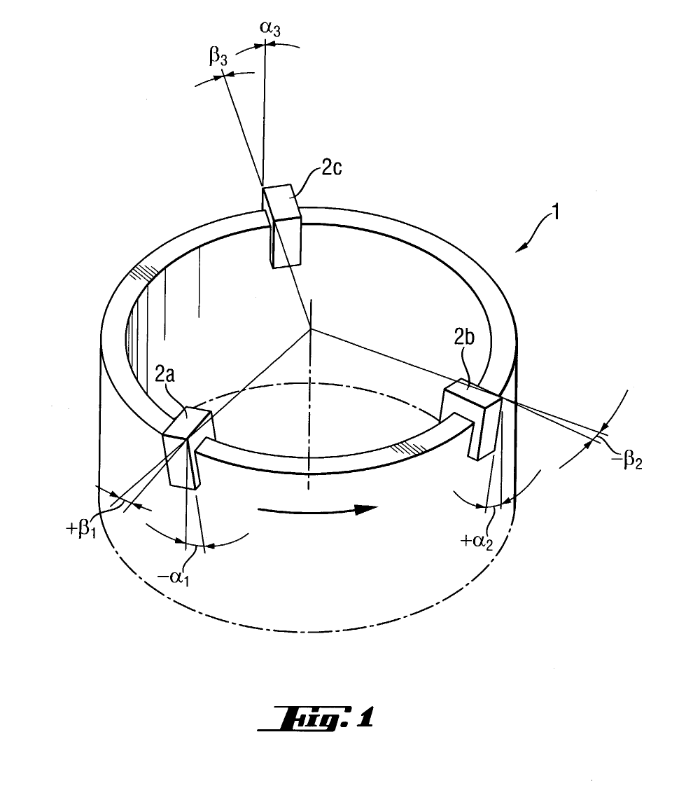

According to FIG. 1, a core drill bit 1 with a tubular axially extending cutting element support is rotatable about its axis and has three geometrically defined, flat PCD cutting elements with a first cutting element 2a with a different axial rake angle α_{1,2} relative to a second cutting element 2b and a radial rake angle β_{1,2}. Accordingly, the cutting element 2a has both an axial rake angle β₁ not equal to zero. A third cutting element 2c has an axial rake angel α₃ and a radial rake angle β₃ of, for example, 0 degrees. The peripherally asymmetrically arranged three different cutting elements 2a, 2b, 2c have axial rake angles in the axial rake angle range of −10°<=α<=+5°, stepped in [−5°, 0°, +5°] and radial rake angles in the radial rake angle range −10°<=β<=+10°, stepped in [−5°, 0°, +5°]. The cutting elements 2a, 2b, 2c have flat end cutting surfaces.

According to FIGS. 2a, 2b, 3a, 3b, 4a and 4b the core drill bit variants have:

a) a cutting element 2a with a positive axial rake angle α₁ and a positive radial rake angle β₁ (FIGS. 2a, 2b);

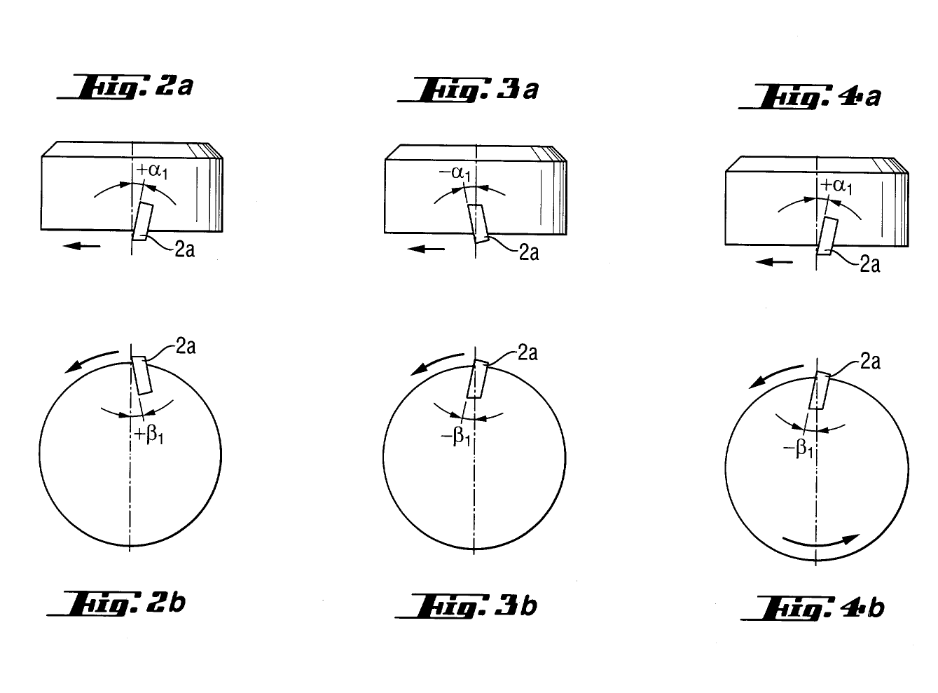

b) a cutting element 2a with a negative axial rake angle α₁ and a negative radial rake angle β₁ (FIGS. 3a, 3b);

c) a cutting element 2a with a positive axial rake angle α₁ and a negative radial rake angle β₁ (FIGS. 4a, 4b).

What is claimed is:

1. A core drill bit comprising an axially extending tubular cutting element support (1a) having an axis of rotation, a leading end surface spaced radially outwardly from said axis of rotation, at least two geometrically defined flat sided cutting elements (2a, 2b) supported in said leading end surface, said cutting elements comprising a first said cutting element (2a) with an axial rake angle (α₁) and a radial rake angle (β₁) and a second cutting element (2b) with an axial rake angle (α₂) and a radial rake angle (β₂) wherein at least one of said axial rake angles (α₁, α₂) and said radial rake angles (β₁, β₂) being different and said cutting elements (2a, 2b) having a flat end cutting surface.

2. A core drill bit, as set forth in claim 1, wherein at least one of said cutting elements (2a, 2b) has a radial rake angle equal to other than zero (β₁, β₂).

3. A core drill bit, as set forth in claim 1, wherein at least one of said cutting elements (2a, 2b) has a positive radial rake angle (β) with said flat end cutting surface tilted in the rotational direction of said cutting element support (1a).

4. A core drill bit, as set forth in claim 1, wherein at least one of said cutting elements (2a, 2b) has a negative axial rake angle (α₁, α₂) and a negative radial rake angle (β₁, β₂).

5. A core drill bit, as set forth in claim 1, wherein at least one of said cutting elements (2a, 2b) has a positive axial rake angle (α₁, α₂) and a negative radial rake angle (β₁, β₂).

6. A core drill bit, as set forth in claim 1, wherein said cutting element support (1a) has at least three said cutting elements each having a different axial rake angle (α_{1, 2, 3}) in the range of −20° to +20° and a radial rake angle (β_{1, 2, 3}) in the range of −20° to +20°.

7. A core drill bit, as set forth in claim 6, wherein the axial rake angles are in the range of −10° to +5° and the radial rake angles are in the range of −10° to +10°.

8. A core drill, as set forth in claim 6, wherein the axial rake angles (α_{1, 2, 3}) are arranged −5°, 0°, +5° and the radial rake angles (β_{1, 2, 3}) are arranged one of −5°, +5° and 0°, +5°.

9. A core drill, as set forth in claim 1, wherein said cutting elements (2a, 2b, 2c) are arranged in a peripheral asymmetrical arrangement.

10. A core drill, as set forth in claim 1, wherein said cutting elements are formed as polycrystalline diamond (PCD) cutting elements.

11. A core drill bit comprising an axially extending tubular cutting element support (1a) having an axis of rotation, a leading end surface spaced radially outwardly from said axis of rotation, at least one geometrically defined flatsided cutting element (2a) supported in said leading end surface having a radial rake angle equal to other than zero (β₁≠0), and said cutting element (2a) having a flat end cutting surface.

12. A core drill bit, as set forth in claim 11, wherein said at least one cutting element (2a) has an axial rake angle equal to other than zero (α₁≠0).

13. A core drill bit, as set forth in claim 12, wherein said at least one cutting element (2a) has a positive axial rake angle with said flat end cutting surface tilted in the rotational direction of said cutting element support (1a) and a positive radial rake angle (β₁) with said flat end cutting surface tilted in the rotational direction of said cutting element support.

14. A core drill bit, as set forth in claim 1, wherein said at least one cutting element (2a) has a negative axial rake angle (α₁) and a negative rake angle (β₁).

15. A core drill bit, as set forth in claim 11, wherein said at least one cutting element (2a) has a positive axial rake angle (α₁) and a negative radial rake angle (β₁).

16. A core drill bit, as set forth in claim 11, wherein said cutting element (2a) is formed as a polycrystalline diamond (PCD) cutting element.
